(19) United States
(12) Patent Application Publication
(10) Pub. No.: US 2011/0138861 A1
(43) Pub. Date: Jun. 16, 2011

(54) OPTICAL FIBER MANUFACTURING METHOD AND APPARATUS

(75) Inventors: Daniel Homa, Blacksburg, VA (US); Charles Giebner, Salem, VA (US)

(73) Assignee: BAKER HUGHES INCORPORATED, Houston, TX (US)

(21) Appl. No.: 12/638,528

(22) Filed: Dec. 15, 2009

(51) Int. Cl. C03B 37/075

(52) U.S. Cl. 65/398

(57) ABSTRACT

A method of manufacturing an optical fiber includes: disposing an axially extending preform structure on a support structure; directing a gas mixture along a major axis of the preform structure in a first axial direction; disposing a heating device proximate to the preform structure; and activating the heating device and moving the heating device along the major axis in a second axial direction to heat the preform structure and deposit at least one layer of material on the preform structure, the second axial direction being opposite to the first axial direction.

### BACKGROUND

Optical fibers have various uses, such as in communication, lasing and sensing. For example, optical fiber sensors are often utilized to obtain various surface and downhole measurements, such as pressure, temperature, stress and strain. Optical fiber cores are generally made from light transmitting material such as silica (SiO₂), that may be doped with various dopants such as chlorine or germanium. Optical fiber claddings may be doped with dopants such as fluorine to lower the refractive index of the cladding and increase the numerical aperture. Manufacture of such fibers is generally accomplished by creating a preform, which is then drawn out into a fiber. Preforms are created via, for example, vapor deposition protocols such as modified chemical vapor deposition (MCVD).

It is well known that achieving high doping levels of fluorine via processes such as MCVD is a challenge. Incorporation of fluorine into glass is diffusion limited, and competing effects limit dopant levels such that the realistic maximum achievable index of refraction difference (“Δn”) is generally less than 0.008. In addition, as dopant levels increase the deposition rate decreases, which limits the manufacturability of the preform. Several methods have been proposed to solve these issues, but do not lend themselves to both achieving high dopant levels and ease of manufacture.

### SUMMARY

A method of manufacturing an optical fiber includes: disposing an axially extending preform structure on a support structure; directing a gas mixture along a major axis of the preform structure in a first axial direction; disposing a heating device proximate to the preform structure; and activating the heating device and moving the heating device along the major axis in a second axial direction to heat the preform structure and deposit at least one layer of material on the preform structure, the second axial direction being opposite to the first axial direction.

A method of manufacturing an optical fiber includes: disposing an axially extending preform structure on a support structure, the preform structure having a first end and a second end; directing a first gas mixture along a major axis of the preform structure in a first axial direction; disposing a heating device proximate to the preform structure; activating the heating device and moving the heating device from the first end toward the second end along the major axis in a second axial direction to heat the preform structure and deposit at least one layer of material on the preform structure, the second axial direction being opposite to the first axial direction; directing a second gas mixture along the major axis in the first axial direction; and sintering the at least one layer by moving the heating device from the second end toward the first end along the major axis in the first axial direction and heating the preform structure.

### BRIEF DESCRIPTION OF THE DRAWINGS

Referring now to the drawings wherein like elements are numbered alike in the several Figures:

FIG. 1 is a cross-sectional view of an embodiment of an optical fiber;

FIG. 2 is a cross-sectional view of an embodiment of an apparatus for manufacturing an optical fiber;

FIG. 3 is a flow chart illustrating an exemplary method of manufacturing an optical fiber; and

FIG. 4 is a flow chart illustrating an exemplary method of manufacturing an optical fiber.

### DETAILED DESCRIPTION

Apparatuses and methods for manufacturing optical fibers are shown. The method includes a deposition process, such as a modified chemical vapor deposition (MCVD) process. In one embodiment, the method includes a “reverse” deposition process for depositing a preform layer, in which a heater is advanced along an optical fiber preform in a direction opposite the direction of deposition gas injection. A sintering and deposition step may be performed that achieves both sintering and doping of the soot layer. The apparatuses and methods allow for the manufacture of optical fibers with higher dopant levels (such as fluorine), which allows for an index difference on the order of about 0.008 or greater and can be easily implemented into the fiber manufacturing process. Furthermore, the apparatuses and methods can reduce the required number of high temperature sintering passes, and thus result in less deformation of the deposition tube throughout the manufacturing process. In one embodiment, the apparatuses and methods are used to fabricate bend insensitive, hydrogen resistant optical fibers.

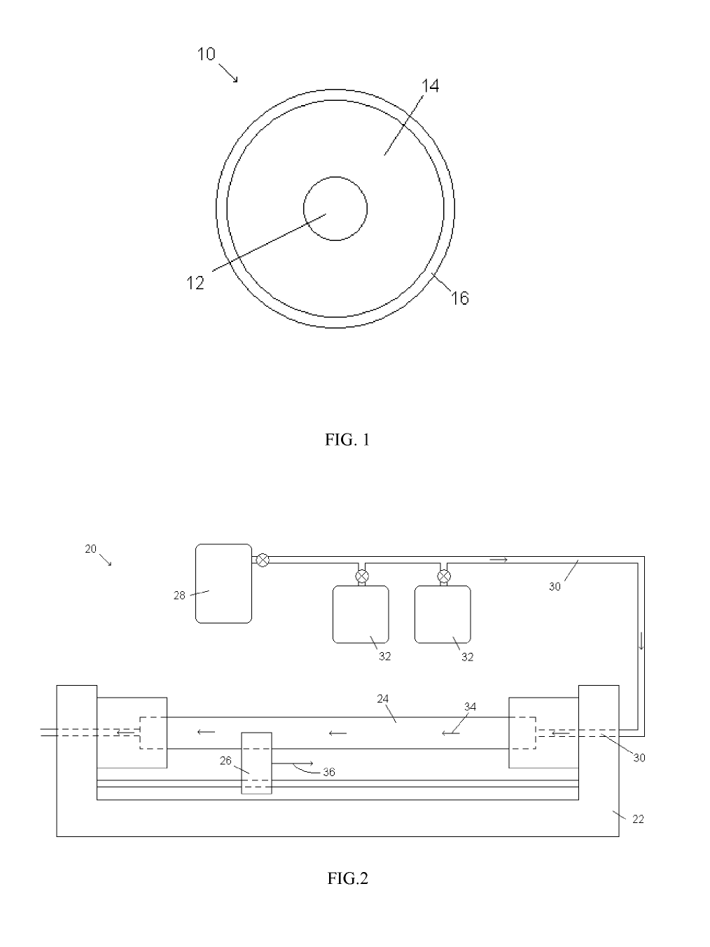

Referring to FIGS. 1A and 1B, a cross-sectional view of an embodiment of an optical fiber 10 is shown. The optical fiber 10 includes a core 12 having a first index of refraction (“n_{core}”) and a cladding 14 having a second index of refraction (“n_{clad}”). The first index of refraction is greater than the second index of refraction, i.e., n_{core}>n_{clad}. The core 12 and/or the cladding 14 may be made from suitable optically conductive materials including glasses such as silica glass or quartz. In one embodiment, the optical fiber 10 is a single mode fiber (SMF) having a core with a constant index of refraction along the radial axis of the core 12. In another embodiment, the optical fiber 10 is a multi-mode fiber having a core with a constant or graded index of refraction. In one embodiment, the optical fiber 10 includes at least one outer layer 16, such as an additional outer cladding layer or a protective layer.

In one embodiment, the optical fiber 10 includes various dopants in the core and/or cladding. For example, the core material may be doped to raise n_{core} relative to an undoped material and/or the cladding material may be doped to lower n_{clad} relative to an undoped material. Examples of core dopant materials include germanium (Ge), tin (Sn), phosphorous (P), tantalum (Ta), titanium (Ti), lead (Pb), lanthanum (La), aluminum (Al), gallium (Ga), antimony (Sb), and any other materials suitable for doping into glass or other core materials. Examples of cladding dopant materials include fluorine (F) and boron (B). Furthermore, active rare earth ions such as erbium, ytterbium, thullium, and neodymium can be co-doped into the core or clad.

In one embodiment, the optical fiber 10 is configured as an optical fiber sensor. In this embodiment, the optical fiber includes at least one measurement unit disposed therein. For example, the measurement unit is a fiber Bragg grating disposed in the core 12 that is configured to reflect a portion of an optical signal as a return signal, which can be detected and/or analyzed to estimate a parameter of the optical fiber 10 and/or a surrounding environment.

The specific materials making up the core 12, cladding 14, outer layer 16 and dopants are not limited to those described herein. Any materials sufficient for use in optical fibers and/or suitable for affecting numerical apertures may be used as desired. In addition, the diameters or sizes of the core 12, cladding 14 and outer layer 16 are not limited, and may be modified as desired or required for a particular design or application. Furthermore, the optical fiber 10 is not limited to the specific material or dopant concentrations described herein.

Referring to FIG. 2, an apparatus 20 for manufacturing an optical fiber preform is illustrated. The apparatus includes a support structure 22 configured to support and hold a preform structure 24, such as a hollow preform tube. The preform structure 24 is made from any suitable material for facilitating deposition of preform layers, such as silica glass. The preform structure 24 may take any desired shape, such as that of a hollow cylinder or other hollow tube and an elongated member such as a cylindrical rod. In one embodiment, the support structure 22 is configured to rotate the preform structure 24 about the major axis of the preform structure 24. A heater 26, such as a furnace or torch, is disposed proximate to the preform structure 24 so as to be able to heat at least a portion of the preform structure 24 when activated, and is movable relative to the preform structure 24. In operation, the heater 26 is moved axially along a major axis of the preform structure 24 while heating sections of the preform structure 24. A source of preform gas 28 is in fluid communication with the interior surfaces or outer surfaces of the preform structure 24 via an inlet conduit 30. Additional gas sources 32 may also be connected to the inlet conduit 32 to supply various gas components, such as dopant materials in conjunction with the preform gas 30.

In one embodiment, during operation, the preform gas mixture is advanced along or injected into the preform structure 24 along a first axial direction 34. As described herein, “axial direction” refers to a direction at least generally parallel to the major axis of the preform structure 24. The heater 26 is activated and advanced in a second axial direction opposite 36 opposite the first axial direction 34. The second axial direction is also referred to as a “reverse” direction 36 relative to the direction of the gas injection. Deposition of at least a soot layer is achieved as the activated heater 26 moves along the preform structure 24 and causes material from the preform gas mixture to react and deposit on a surface of the preform structure 24.

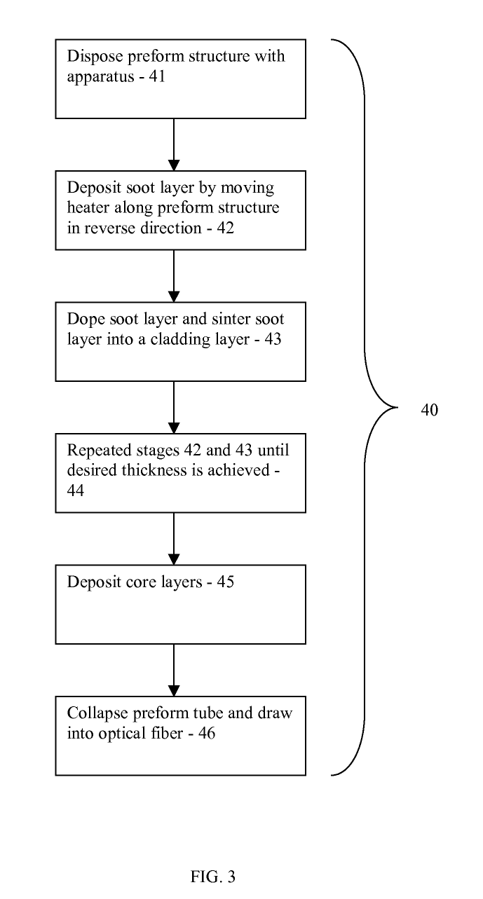

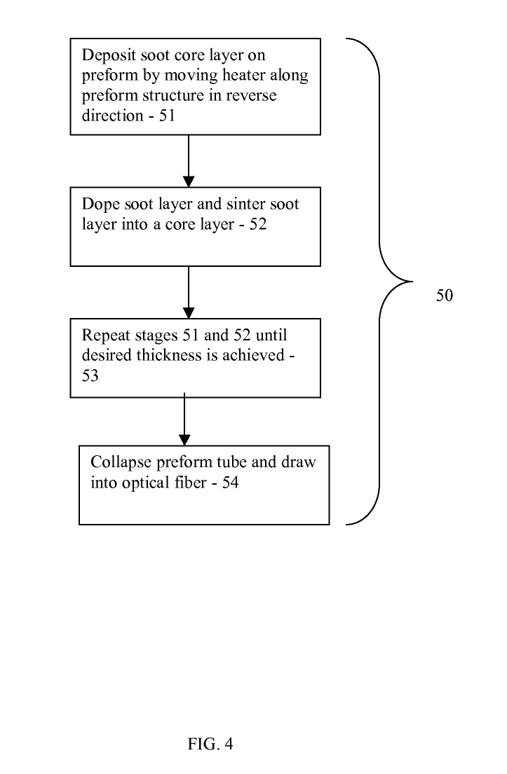

FIG. 3 illustrates a method 40 of manufacturing the optical fiber 10. The method 40 includes one or more stages 41-46. Although the method 40 is described in conjunction with the apparatus 20, the method 40 may be utilized in conjunction with any apparatus or system capable of deposition. In one embodiment, the method 40 includes the execution of all of stages 41-46 in the order described. However, certain stages may be omitted, stages may be added, or the order of the stages changed.

In the first stage 41, a preform structure (e.g., the preform structure 24) such as a pure silica glass tube is operably positioned with a deposition apparatus, such as the apparatus 20. In one embodiment, the tube is positioned so that a heater such as the heater 26 is movable along the length of the tube. In one embodiment, the tube is mounted on a lathe or other support structure, such as the support structure 22, and may be rotated during the following stages.

In the second stage 42, a first gas mixture including, for example, oxygen and silicon tetrachloride (SiCl₄) is injected into the interior of the tube via a suitable flow line and passed through the tube to form a cladding layer. The heater is activated and advanced along the length of the tube, causing a fine soot of silica to be deposited on the inner surface of the tube via chemical reactions in the first gas mixture. The tube is rotated and heated to a high temperature such as on the order of 1600° C.

Deposition is performed, in one example, by introducing the first gas mixture into the interior of the tube in a first axial direction along the major axis of the tube. The first direction may be referred to as a “forward” or “downstream” direction. The heater is activated and moved along the length of the tube in a second axial direction. In one embodiment, the second axial direction is a “reverse” or “upstream” direction, or direction opposite the first axial direction. As the heater moves along the tube, the heater heats the tube to a temperature sufficient to cause the soot layer to form on the inner surface. Depositing the soot layer in the “reverse” direction aids in achieving a highly porous soot layer.

In the third stage 43, the soot is sintered or consolidated. The soot is sintered, typically in an atmosphere of helium gas, to form a solid glass cladding layer on an inside surface of the tube. In one embodiment, the soot is sintered in an atmosphere containing a second gas mixture including helium (or other gases) and at least one dopant material, such as silicon tetrafluoride (SiF₄). Other doping materials may be included as desired, such as boron and/or tin. The doping substance is selected, for example, to lower the refractive index of the cladding layer relative to an undoped layer.

Sintering is performed, in one example, by introducing the second gas mixture into the interior of the tube, and moving the burner in either the first (or downstream) direction or the second (or upstream) direction. The heater heats the tube to a second temperature while moving along the tube, which in one embodiment is greater than the first temperature (e.g., 1800° C.) and sufficient to sinter the soot layer. During this stage, the soot layer is doped with the doping material and agglomerated into a doped cladding layer.

In one embodiment, both the deposition stage 42 and the sintering/doping stage 43 are performed as a single uninterrupted preform layer forming process. For example, the heater is activated to heat the tube to a first temperature (e.g., 1600° C.) and the soot layer is deposited by advancing the heater from a first end of the tube in the reverse direction while a first gas mixture (i.e., the deposition gas mixture) is introduced into the tube at a second end of the tube and flowed through the tube in the forward direction. When the heater reaches the second end of the tube, the second gas mixture is introducing into the interior of the tube via the flow line, and the heater is activated to heat the preform structure to a second higher temperature. The second gas mixture, including desired dopants, is introduced into the tube at the second end, and the heater is advanced in the forward direction to heat the tube, and cause the soot layer to be doped and sintered into a solid cladding layer. This procedure is advantageous in that it is more efficient and requires less time than conventional procedures. For example, the procedure described herein eliminates the additional time needed for cooling and re-heating the heater and reduces the amount of movement of the heater required to form the cladding layers.

In the fourth stage 44, the deposition stage 42 and the sintering/doping stage 43 are optionally repeated as desired in order to achieve a desired cladding layer thickness.

In the fifth stage 45, a third gas mixture is passed through the tube to form a precursor of the core. The gas mixture includes, for example, oxygen and SiCl₄ to form a silica layer, and may also include various dopants. The dopants include various materials that increase or otherwise change the numerical aperture of the core relative to an undoped core. Examples of such dopants include germanium (Ge), tin (Sn), phosphorous (P), tantalum (Ta), titanium (Ti), lead (Pb), lanthanum (La), aluminum (Al), Gallium (Ga), antimony (Sb), and any other materials suitable for doping into glass or other core materials. A soot layer is formed on the inner surface of the cladding layer. This stage may include both a deposition stage and a sintering stage.

Deposition is performed, in one example, by introducing a gas mixture into the interior of the tube in a first axial direction along the major axis of the tube. The heater is activated and moved along the length of the tube in a second axial direction, which is either a forward direction or a reverse direction. In one embodiment, sintering is performed by introducing another gas mixture into the interior of the tube, and moving the burner in either the forward or the reverse direction. The gas mixture includes any desired dopants to dope the soot layer during the sintering stage. In one embodiment, similarly to the cladding formation stage described above, both deposition and sintering/doping are performed as a single uninterrupted layer forming process.

In the sixth stage 46, the tube is collapsed by heating to form the finished preform. The preform may then be drawn into an optical fiber. Any number or type of protective coatings are optionally applied to the exterior surface of the cladding.

The method 40, although described in conjunction with MCVD, can be utilized in conjunction with any number of various deposition processes. Such processes include chemical vapor deposition (CVD), vapor axial deposition (VAD), plasma chemical vapor deposition (PCVD), and outside vapor deposition (OVD).

FIG. 4 illustrates a method 50 of manufacturing the optical fiber 10. The method 50 includes one or more stages 51-54. Although the method 50 is described in conjunction with the apparatus 20, the method 50 may be utilized in conjunction with any apparatus or system capable of deposition. In one embodiment, the method 50 includes the execution of all of stages 51-54 in the order described. However, certain stages may be omitted, stages may be added, or the order of the stages changed.

In the first stage 51, a first gas mixture including, for example, oxygen and SiCl₄ is injected into an interior of a preform structure such as a pure silica glass tube and passed through the tube to form a core layer. In one embodiment, the preform structure includes one or more cladding layers formed by, for example, the method 40. The heater is activated and advanced along the length of the tube, causing a fine soot of silica to be deposited on the inner surface of the tube via chemical reactions in the first gas mixture.

Deposition is performed, for example, by introducing the first gas mixture into the interior of the tube in the forward direction. The heater is activated and moved along the length of the tube in the reverse direction opposite the forward direction. As the heater moves along the tube, the heater heats the tube to a temperature sufficient to cause the soot layer to form on the inner surface of the cladding layer(s).

In the second stage 52, the soot is sintered or consolidated. The soot is sintered, typically in an atmosphere of helium gas, to form a solid core layer on an inside surface of the cladding layer(s). In one embodiment, the soot is sintered in an atmosphere containing a second gas mixture including helium (or other gases) and at least one dopant material, such as germanium. The doping substance is selected, for example, to raise the refractive index of the core layer relative to an undoped layer.

Sintering is performed, in one example, by introducing the second gas mixture into the interior of the tube, and moving the burner in either the forward (or downstream) direction or the reverse (or upstream) direction. The heater heats the tube to a second temperature while moving along the tube, which in one embodiment is greater than the first temperature and sufficient to sinter and dope the soot layer.

In one embodiment, both the deposition stage 51 and the sintering/doping stage 52 are performed as a single uninterrupted preform layer forming process, similar to that described in conjunction with the method 40. For example, the heater is activated to heat the tube to a first temperature and the soot layer is deposited by advancing the heater from a first end of the tube in the reverse direction while a first gas mixture (i.e., the deposition gas mixture) is introduced into the tube at a second end of the tube and flowed through the tube in the forward direction. When the heater reaches the second end of the tube, the second gas mixture is introducing into the interior of the tube via the flow line, and the heater is activated to heat the preform structure to a second higher temperature. The second gas mixture, including desired dopants, is introduced into the tube at the second end, and the heater is advanced in the forward direction to heat the tube, and cause the soot layer to be doped and sintered into a solid core layer.

In the third stage 53, the deposition stage 51 and the sintering/doping stage 52 are optionally repeated as desired in order to achieve a desired cladding layer thickness.

In the fourth stage 54, the tube is collapsed by heating to form the finished preform. The preform may then be drawn into an optical fiber. Any number or type of protective coatings are optionally applied to the exterior surface of the cladding.

The method 50, although described in conjunction with MCVD, can be utilized in conjunction with any number of various deposition processes, such as CVD, VAD, PCVD and OVD.

The optical fibers, apparatuses and methods described herein provide various advantages over existing methods and devices. For example, the method described herein results in various improvements over prior art processes, such as increased dopant concentration, improved or optimized gas flows, increased preform tube diameter, increased SiO₂ soot thickness, and lower processing temperatures. For example, the reverse deposition process produces a soot layer that is more porous than soot layers resulting from conventional processes, and which is thus capable of retaining higher concentrations of dopants. The resulting fibers exhibit a Δn of the doped cladding that is greater than prior art fibers, while being easier to manufacture. Furthermore, the method and apparatus described herein is capable of manufacturing optical fibers having low bend sensitivity and high hydrogen resistance.

In connection with the teachings herein, various analyses and/or analytical components may be used, including digital and/or analog systems. The apparatus may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention.

1. A method of manufacturing an optical fiber comprising:
disposing an axially extending preform structure on a support structure;
directing a gas mixture along a major axis of the preform structure in a first axial direction;
disposing a heating device proximate to the preform structure; and
activating the heating device and moving the heating device along the major axis in a second axial direction to heat the preform structure and deposit at least one layer of material on the preform structure, the second axial direction being opposite to the first axial direction.

2. The method of claim 1, further comprising sintering the at least one layer by directing another gas mixture along the major axis and moving the heating device along the major axis to agglomerate the at least one layer.

3. The method of claim 2, wherein the another gas mixture includes at least one dopant, and sintering includes doping the layer with at least one dopant.

4. The method of claim 3, wherein the layer is a cladding layer, and the at least one dopant is selected from at least one of fluorine and boron.

5. The method of claim 3, wherein the layer is a core layer, and the dopant is selected from at least one of germanium, tin, phosphorous, tantalum, titanium, lead, lanthanum, aluminum, gallium, antimony, erbium, ytterbium, neodymium, and thullium.

6. The method of claim 2, wherein sintering includes moving the heating device along the major axis in the first axial direction.

7. The method of claim 1, wherein the heating device heats the preform structure to a first temperature to deposit the at least one layer and heats the preform structure to a second temperature to sinter the at least one layer, the second temperature being higher than the first temperature.

8. The method of claim 1, further comprising rotating the preform structure about the major axis during the depositing.

9. The method of claim 1, wherein the method is a modified chemical vapor deposition (MCVD) method.

10. The method of claim 1, wherein the preform structure is made of a material including silica glass.

11. The method of claim 1, wherein the support structure is a lathe.

12. The method of claim 1, wherein the preform structure is a hollow tube, and the at least one layer is deposited on an inner surface of the tube.

13. The method of claim 2, wherein the at least one layer includes at least one cladding layer and at least one core layer.

14. The method of claim 13, wherein the preform structure is a hollow tube, and the method further comprises collapsing the cladding layers and core layers into an optical fiber preform.

15. The method of claim 14, further comprising drawing the optical fiber preform into an optical fiber.

16. A method of manufacturing an optical fiber comprising:
disposing an axially extending preform structure on a support structure, the preform structure having a first end and a second end;
directing a first gas mixture along a major axis of the preform structure in a first axial direction;
disposing a heating device proximate to the preform structure;
activating the heating device and moving the heating device from the first end toward the second end along the major axis in a second axial direction to heat the preform structure and deposit at least one layer of material on the preform structure, the second axial direction being opposite to the first axial direction;
directing a second gas mixture along the major axis in the first axial direction; and
sintering the at least one layer by moving the heating device from the second end toward the first end along the major axis in the first axial direction and heating the preform structure.

17. The method of claim 16, wherein the second gas mixture includes at least one dopant, and sintering the at least one layer includes doping the at least one layer with the at least one dopant.

18. The method of claim 16, wherein the heating device heats the preform structure to a first temperature to deposit the at least one layer and heats the preform structure to a second temperature to sinter the at least one layer, the second temperature being higher than the first temperature.

19. The method of claim 16, wherein the second gas mixture includes at least one dopant, and sintering includes doping the layer with at least one dopant.

20. The method of claim 16, wherein the layer is one of a cladding layer and a core layer.
